(19) United States
(12) Patent Application Publication
(10) Pub. No.: US 2012/0145487 A1
(43) Pub. Date: Jun. 14, 2012

(54) Elevator Using Variable Communication Protocol and Its Control Method

(76) Inventor: Jae Hyeok Yoo, Daegu (KR)

(21) Appl. No.: 13/389,067

(22) PCT Filed: May 27, 2011
(86) PCT No.: PCT/KR2011/003930

§ 371 Date: Feb. 28, 2012

(30) Foreign Application Priority Data
Jun. 8, 2010 (KR) 10-2010-53669

(51) Int. Cl. B66B 1/14

(52) U.S. Cl. 187/380

(57) ABSTRACT

Disclosed are an elevator using variable communication protocol and its control method which makes it possible to operate elevators which uses different communication protocols between an operation control part controlling an operation of an elevator and an elevator hall and between an operation control part and an up and down passage operation part. The elevator using a variable communication protocol comprises an up and down passage operation part which detects and outputs an elevator call and a floor selection signal from a passenger of an elevator and displays an operation state of the elevator based on the call and the floor selection; an elevator operation control part which outputs an operation control signal allowing the elevator to work in accordance with a call and floor selection signal of the elevator from the up and down passage operation part and an operation display signal for a display of the operation state and the arrival state of the elevator; and a protocol conversion part which converts a communication protocol of the up and down passage operation part or the elevator operation control part for a data communication between the up and down passage operation part and the elevator operation control part hen different communication protocols are used in terms of the signals between the up and down passage operation part and the elevator operation control part.

### TECHNICAL FIELD

The present invention relates to an elevator, and in particular to an elevator using variable communication protocol and its control method which makes it possible to operate elevators which uses different communication protocols between an operation control part controlling an operation of an elevator and an elevator hall and between an operation control part and an up and down passage operation part.

### BACKGROUND ART

Elevator is generally equipped with an indication window disposed at a hall provided at every floor of a multiple-story building for indicating the position of an elevator, and a hall call button calling an elevator, and in the interior of an elevator are provided floor selection buttons for a passenger to select a desired floor.

FIG. 1 is a perspective view illustrating the construction of a conventional elevator. As shown therein, the elevator 10 is formed of an elevator hall 11 disposed at one side of a building and waiting for a passenger to get on or off an elevator 10, and a rectangular riding part 20 is disposed between an elevator door 21 and the elevator hall 11.

A hall call button 22 is installed at one side of the elevator hall 11 for calling the elevator 10, and an operation panel 23 is installed along with a plurality of floor selection buttons 24 in the inner side of the riding part 20.

The passenger who wants to get on an elevator 10 calls the elevator 10 by pushing the hall call button 22, and the passenger in the called elevator 10 can move to a desired floor by designating a desired floor by pushing the floor selection button 24 disposed in the interior of the elevator.

The conventional elevator 10 has a problem in that when a lot of passengers are on an elevator, it is very hard to push a floor selection button 24. In order to overcome the above problems, in case of large size elevator, two sets of button parts for the selection of a desired floor are installed in the interior of the elevator. In recent years, an elevator with a voice recognition function, not buttons 22 and 24, is disclosed.

The elevators use different, but a little similar elevator operation control methods depending on the manufacturers.

However, the signals used for an operation control of the elevator use different communication protocols, so a company that installed the elevator when a budding is built has an exclusive right for a maintenance, so the maintenance costs a lot.

When it is needed to exchange the existing elevator, the different communication protocols cannot be used when the installed elevator is no longer manufactured. The parts cannot be used between the elevator manufacturers due to the different communication protocols, which results in an increased part price, and it is impossible to effectively cope with accidents.

### DISCLOSURE OF INVENTION

Accordingly, the present invention is made to overcome the above problems and it is an object of the present invention to provide an elevator using variable communication protocols which makes it possible to operate elevators which uses different communication protocols between an operation control part controlling an operation of an elevator and an elevator hall and between an operation control part and an up and down passage operation part.

It is another object of the present invention to provide a control method of an elevator using variable communication protocols which makes it possible to allow an elevate to work by changing a communication protocol between an elevator operation control part using a different communication protocol and an up and down passage control part.

To achieve the above objects, there is provided an elevator using a variable communication protocol, comprising an up and down passage operation part which detects and outputs an elevator call and a floor selection signal from a passenger of an elevator and displays an operation state of the elevator based on the call and the floor selection; an elevator operation control part which outputs an operation control signal allowing the elevator to work in accordance with a call and floor selection signal of the elevator from the up and down passage operation part and an operation display signal for a display of the operation state and the arrival state of the elevator; and a protocol conversion part which converts a communication protocol of the up and down passage operation part or the elevator operation control part for a data communication between the up and down passage operation part and the elevator operation control part hen different communication protocols are used in terms of the signals between the up and down passage operation part and the elevator operation control part.

In addition, the protocol conversion part comprises a protocol transceiver part for transmitting and receiving a communication protocol between the up and down passage operation part and the elevator operation control part; a protocol analysis part which analyzes a communication protocol transmitted to and received from the protocol transceiver part and outputs as a previously set communication protocol between the up and down passage operation part and the elevator operation control part; and a protocol control part which outputs an operation signal to the up and down passage operation part or the elevator operation control part in accordance with the communication protocol from the protocol analysis part.

There are further provided in the present invention a protocol setting part for setting a manufacturer information of the up and down passage operation part and the elevator operation control part; and a protocol table for storing a communication protocol data previously set in accordance with the manufacturer of the up and down passage operation part and the elevator operation control part set from the protocol setting part.

In addition, there is further provided a voice recognition part which is installed at the up and down passage operation part or the elevator operation control part for thereby detecting and outputting an elevator call and a floor selection signal in a way of voice recognition from the passenger of the elevator.

To achieve the above object, there is provided a control method using a variable communication protocol, comprising (a) a step in which a protocol conversion part detects an elevator operation signal from the up and down passage operation part and the elevator operation control part; (b) a step in which when the elevator operation signals use different communication protocols, the protocol conversion part analyzes the communication protocols of the up and down passage operation part and the elevator operation control part so that a data communication can be made between the up and down passage operation part and the elevator operation control part, and converts one communication protocol of the up and down passage operation part or the elevator operation control part in accordance with the analyzed result; and (c) a step in which the protocol conversion part allows an elevator operation signal to be transmitted and received between the up and down passage operation part and the elevator operation control part in accordance with the determined communication protocol.

In the present invention, the step (b) comprises a step in which the protocol conversion part detects a manufacturer information of the up and down passage operation part and the elevator operation control part; a step for searching a communication protocol data table of the previously set manufacturer in accordance with the detected manufacturer information; and a step in which the communication protocol data table of the searched manufacturer is set as a communication protocol conversion table between the up and down passage operation part and the elevator operation control part, and the elevator operation signal converted based on the set communication protocol data table is transmitted and received.

### ADVANTAGEOUS EFFECTS

The present invention has an advantage in that even when signals for an operation control of an elevator use different communication protocols, the elevator can work.

In the present invention, the parts can be exchanged and used between the elevator manufacturers by changing the communication protocols, and the prices of the parts due to the maintenance can be saved, and it is possible to quickly cope with accidents.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating the construction of a conventional elevator;

FIG. 2 is a block diagram of the construction of an elevator using a variable communication protocol according to the present invention;

FIG. 3 is a block diagram of a construction of a protocol conversion part of FIG. 2;

FIG. 4 is a block diagram of a construction of an elevator operation control part of FIG. 2;

FIG. 5 is a block diagram of a construction of an up and down passage operation part of FIG. 2;

FIG. 6 is a flow chart of a control procedure of an elevator using a variable communication protocol according t the present invention; and

FIG. 7 is a flow chart of a protocol analysis and determination procedure of FIG. 6.

### BEST MODES FOR CARRYING OUT THE INVENTION

The elevator using a variable communication protocol and its control method according to the present invention will be described with reference to the accompanying drawings.

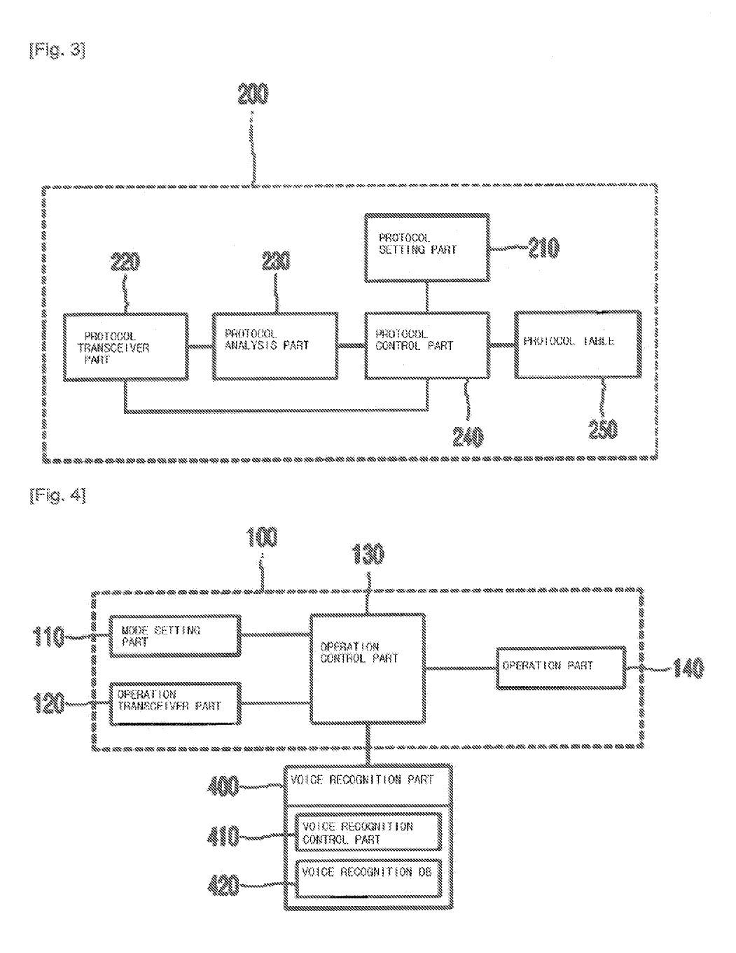

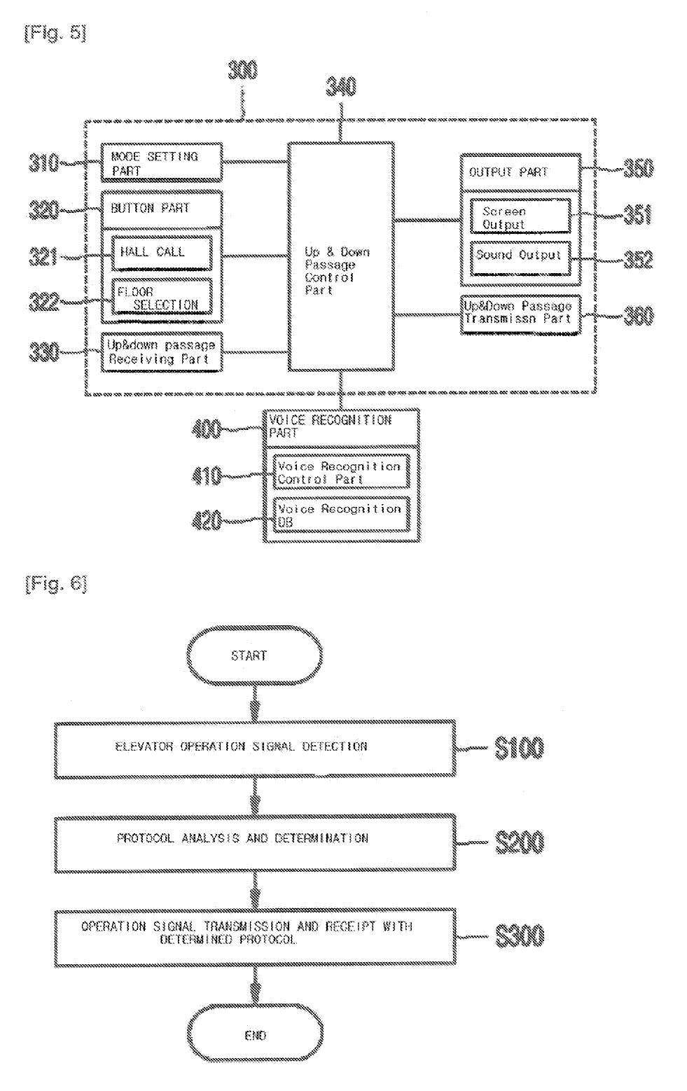

FIG. 2 is a block diagram of the construction of an elevator using a variable communication protocol according to the present invention, and FIG. 3 is a block diagram of a construction of a protocol conversion part of FIG. 2, and FIG. 4 is a block diagram of a construction of an elevator operation control part of FIG. 2, and FIG. 5 is a block diagram of a construction of an up and down passage operation part of FIG. 2.

As shown in FIGS. 2 to 5, the elevator using a variable communication protocol according to the present invention comprises an elevator operation control part 100, a protocol conversion part 200 for converting a communication protocol, an up and down passage operation part 300 for detecting an operation information of elevator from passenger and allowing an operation state of an elevator to be displayed, and a voice recognition part 400 performing a detection of an operation information with a voice recognition.

The elevator operation control part 100 comprises a mode setting part 110 and an operation transceiver part 120 installed at a machine room of a building, and an operation control part 130 and an operation part 140.

The mode setting part 110 receives at least on operation information between an operation information by way of the button input in a conventional way and an operation information by way of the voice recognition part 400, thus operating the elevator.

The mode setting part 110 is formed of a switch or the like, and can set a button input, a voice recognition input, a button input plus a voice recognition input depending on a selection of an elevator manager.

The operation transceiver part 120 is a construction for a data transmission and receipt with an external device, and serves to receive a data that the protocol conversion part 200 or the up and down passage operation part 300 transmits and transmits an operation control signal from the operation control part 130 to the outside.

The operation control part 130 is a construction for controlling the entire operations of the elevator, and is designed to output an operation control signal of an elevator for controlling an elevator in accordance with an elevator call an a floor selection signal from the up and down passage operation part 300, and an operation display signal for displaying an operation state and arrival floor of an elevator.

When the voice recognition is set by the mode setting part 10, the operation control part 130 outputs a control signal for allowing the elevator to operate in accordance with a call of an elevator and floor selection signal inputted from the voice recognition part 400.

The operation part 140 includes an elevator car and a driving motor for operating the elevator in accordance with an operation control signal of the elevator from the operation control part 130.

The protocol conversion part 200 is directed to converting a communication protocol of the elevator operation control part 100 or the up and down passage operation part and outputting the converted protocol so that a data communication can be possible between the elevator operation control part 100 and the up and down passage operation part 300 when the signals from the elevator operation control part 100 and the up and down passage operation part 300 use different communication protocols and is formed of a protocol setting part 210, a protocol transceiver part 220, a protocol analysis part 230, a protocol control part 240, and a protocol table 250.

The protocol setting part 210 provides an information on the manufacturer of the elevator operation control part 100 and the up and down passage operation part 300 and sets the communication protocol to convert based on the communication protocol information of the provided manufacturer.

The protocol setting part 210 allows the communication protocol information of the elevator operation control part 100 and the up and down passage operation part 300 to be automatically set based on the manual setting (for example, the selection of a previously set manufacturer by way of switch) by an elevator manager or the information of the manufacturer obtained from the data communication to be used to check the manufacturer of the elevator operation control part 10 and the up and down passage operation part 300.

The information of the manufacturer obtained from the data communication for checking the manufacturer can be checked and obtained by analyzing the signals returned as the previously set communication protocol signals by the manufacturer are sequentially transmitted.

The protocol transceiver part 220 performs a data transmission and receiving operation with the elevator operation control part 100 depending on the previously set communication protocol and performs a data transmission and receiving function with the up and down passage operation part 300 depending on the previously set communication protocol.

The protocol analysis part 230 analyzes the communication protocol transmitted and received by way of the protocol transceiver part 220 and outputs a communication protocol corresponding to the analyzed result, thus making a data communication possible even when the different communication protocols are used between the elevator operation control part 100 and the up and down passage operation part 300.

The protocol analysis part 230 analyzes a manufacturer communication protocol of the elevator operation control part 10 and detects a corresponding command when an operation control signal is received from the elevator operation control part 100 and then searches the manufacturer communication protocol of the up and down passage operation part 300 and provides the same.

The protocol control part 240 outputs a signal of a corresponding command related to the operation to the elevator operation control part 100 or the up and down passage operation part 400 based on the communication protocol from the protocol analysis part 230.

The protocol table 250 stores a communication protocol used by the manufacturers of the elevator operation control part 100 and the up and down passage operation part 300 set based on the protocol setting part 210.

The protocol table 250 stores an operation control signal of each manufacturer related to the operation of the elevator, a control signal related with the hall call and floor selection, a display signal for displaying an operation state of the elevator, and a communication protocol information of each manufacturer corresponding to a corresponding signal.

The up and down passage operation part 30 detects and outputs an elevator call and floor selection signal from the passenger of the elevator and displays an operation state of the elevator based on the call and floor selection and is formed of a mode setting part 310, a button part 320 for a hall call and floor selection, an up and down passage receiving part 30, an up and down passage control part 340, an output part 350 for outputting a screen and sound and an up and down passage transmission part 360.

The mode setting part 310 is directed to allowing the elevator to operate by receiving an operation information as the button is inputted in a conventional way and an operation information from the voice recognition part 400.

The mode setting part 310 is formed of a switch and provides a setting function of a button input, a voice recognition input, a button input plus a voice recognition input depending on the selection of the elevator manager.

The button part 320 is installed at the elevator hall and the interior of the elevator and is directed to outputting a call signal and an operation control signal of the elevator as the passenger pushes for the use of the elevator and is formed of a all call button 321 and a floor selection button 322 including a door open and a door close function which provides the operation information for an elevator to move to a corresponding floor.

The up and down passage receiving part 330 receives a control signal related to the operation of the elevator from the protocol conversion part 200 depending on the previously set communication protocol.

The up and down passage control part 340 allows the hall call and floor selection signal from the button part 320 to be transmitted to the protocol conversion part 200 by way of the up and down passage transceiver part 360 and outputs a display signal for helping the output part 350 formed of a LED, LCD and speakers to operate in accordance with a control signal related to the operation of the elevator from the up and down passage receiving part 330.

The up and down passage control part 340 allows the call and floor selection signal of the elevator to be outputted via the up and down passage transceiver part 360 as the call and floor selection signals are inputted based on a voice recognition of the voice recognition part 400 when the voice recognition function is set by the mode setting part 310.

The output part 350 is formed of at least one among the LED and LCD for the screen output 351 and a speaker for the sound output 352.

The screen output 351 formed of a LED and a LCD is configured in a turn on and off way or a display way for displaying a result of an operation state of an elevator, a hall call and a floor selection in accordance with a display signal from the up and down passage control part 340.

The sound output 352 formed of a speaker is designed to output a sound form a result of the door opening and closing state of the elevator, a hall call and a floor section in accordance with a display signal from the up and down control part 340.

The up and down passage transceiver part 360 outputs a hall call of the elevator, a door opening and closing state and a floor selection signal from the up and down passage control part 340 to the protocol conversion part 200 in accordance with a previously set communication protocol.

The voice recognition part 400 is installed at the elevator operation control part 100 or the up and down passage operation part 300 and is a construction for providing the elevator hall call and the floor selection information from the voice signal of the elevator passenger by way of the voice recognition and is formed of a voice recognition control part 410 and a voice recognition DB 420.

The voice recognition part 400 waits for the voice from the elevator passenger and a previously set voice information, and detects a key word from the voice, and recognizes the information of the hall call and the current floor and outputs an operation control signal of the elevator and a recognized signal to the operation control part 130 or the up and down passage control part 340 in a voice form based on the recognized information.

The voice recognition control part 410 detects a voice of the passenger by way of the microphone(not shown) installed at the elevator hall or in the interior of the elevator and removes noises from the recorded voice and amplifies the same and analyzes and detects the key frequency and outputs the amplified voice information.

The voice recognition control part 410 detects work and phoneme of the voice and compares the features of the voice with the voice information stored in the voice recognition DB 420 and extracts and read the voice information (for example, key words) needed for the operation of the elevator corresponding to the language recognized based on the feature of the voice and the mathematically analyzed phoneme, group and language features.

The key words are voice information needed to control the operation of the elevator and are formed of the words related with up and down operation in case of the hall call such as “up”, “down” or “going down”, and in case of the floor selection, it is formed of the words related to the floor to move to such as “lobby”, “first floor”, “first basement” or “fifth floor”.

The voice recognition control part 410 recognizes a corresponding signal from the voice recognition program and performs a sound output check which rejects or approve the recognition.

The voice information stored in the voice recognition DB 420 is analyzed thus judging the non-recognition word or the non-key words and the key words, and the recognition is performed along with the sound or dialogue in order to remove the error operation which might occur in the voice recognition program.

In terms of the recognized voices, it is checked if the passenger has voiced a key word (operation command) needed for the operation of the elevator by way of the non-recognition word and the phoneme by means of anti-phoneme, thus verifying the reliability, and when the key word is reliable after the check, the recognition is performed, and a corresponding operation information is provided, and when the recognized key word is not reliable, the recognition is not performed, and the operation information is not provided, and the signal of informing an error in the voice recognition is outputted.

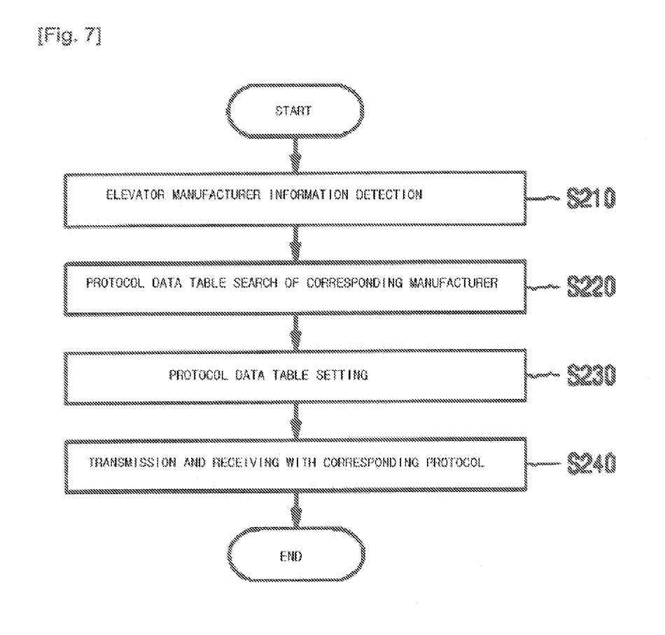

FIG. 6 is a flow chart of a control procedure of an elevator using a variable communication protocol according t the present invention, and FIG. 7 is a flow chart of a protocol analysis and determination procedure of FIG. 6. The control method of an elevator using a variable communication protocol according to the present invention will be described.

The protocol conversion part 200 detects elevator operation signals from the elevator operation control part 100 and the up and down passage operation part 300 in a step S100.

The protocol conversion part 200 analyzes the communication protocol of the elevator operation signals detected in the step S100, and as a result when the elevator operation control part 100 and the up and down passage operation part 300 use the same communication protocols, a data transmission and receiving is made possible between the elevator operation control part 100 and the up and down passage operation part 300, and when they use different communication protocols, it is decided that the communication protocol of either the elevator operation control part 100 or the up and down passage operation part 300 is converted based on the corresponding communication protocol previously set between the elevator operation control part 100 and the up and down passage operation part 300 in a step S200.

The step S200 will be described in details. The protocol conversion part 200 detects the manufacturer information of the elevator operation control part 100 and the up and down passage operation part 300 in a step S210.

The manufacturer information detection process of the step 3210 can be performed using the manufacturer information of the elevator operation control part 100 and the up and down passage operation part 300, and the manufacturer information can be detected from the information returning from the elevator operation control part 100 and the up and down passage operation part 300 by way of the communication for the check of the manufacturer of the elevator operation control part 100 and the up and down passage operation part 300.

Based on the information of the manufacturer detected in the step S210, the protocol convention part 200 searches the protocol table 250 storing the previously set manufacturer-by communication protocol data in a step S220, and the searched protocol table 250 is set as a communication conversion protocol table between the elevator operation control part 100 and the up and down passage operation part 300 in a step S230, and based on the set communication protocol table 250, the signals transmitted and received between the elevator operation control part 100 and the up and down passage operation part 300 in a step S240.

When the operation control signal is inputted from the elevator operation control part 100, the protocol conversion part 200 converts the communication protocol of the elevator operation control part 100 into a communication protocol of the up and down passage operation part 00.

In addition, when a control signal related to the hall call and the floor selection from the up and down passage operation part 00 is transmitted, the protocol conversion part 200 converts the communication protocol of the up and down passage operation part 300 into the communication protocol of the elevator operation control part 100.

Based on the communication protocol converted in the step S200, the protocol conversion part 200 transmits or receives the signals related to the operation to the elevator operation control part 100 or the up and down passage operation part 300 in accordance with the converted communication protocol.

In the present invention, it is possible to transmit or receive the signals related to the operations even when different communication protocols are used between the elevator manufacturers.

So far, the preferred embodiments of the present invention has been described, but it is obvious that an ordinary person skilled in the art can change and modify the present invention is various ways without escaping the scope of the concept and field of the present invention recited in the following claims.

| | |
|---|---|
| 100: elevator operation control part | 110: mode setting part |
| 120: operation transmission and receiving | |
| part | |
| 130: operation control part | |
| 140: operation part | 200: protocol conversion part |
| 210: protocol setting part | 220: protocol transmission |
| | and receiving part |
| 230: protocol analysis part | 240: protocol control part |
| 250: protocol table | 300: up and down passage |
| | operation part |
| 310: mode setting part | 320: button part |
| 321: hall call | 322: floor selection |
| 330: up and down passage receiving part | |
| 340: up and down passage control part | |
| 350: output part | 351: screen output |
| 352: sound output | 360: up and down passage |
| | transmission part |
| 400: voice recognition part | 410: voice recognition control |
| | part |
| 420: voice recognition DB | |

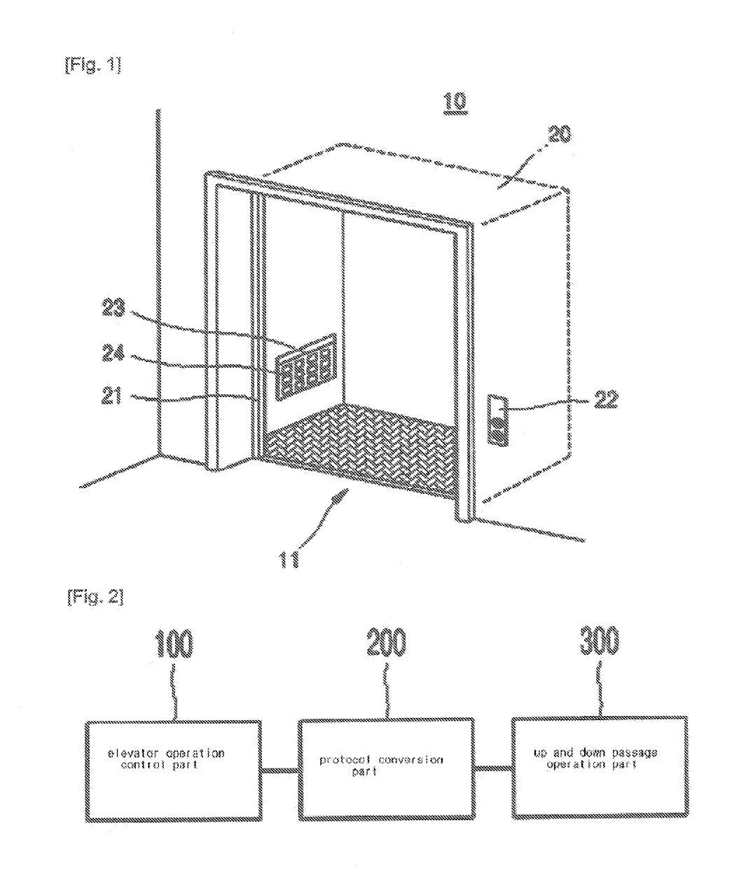

FIG. 1
FIG. 2
100: elevator operation control part
200: protocol conversion part
300: up and down passage operation part
FIG. 3
220: protocol transceiver part
230: protocol analysis part
210: protocol setting part
240: protocol control part
250: protocol table
FIG. 4
110: mode setting pat
120: operation transceiver part
130: operation control part
140: operation part
400: voice recognition part
410: voice recognition control part
420: voice recognition DB
FIG. 5
310: mode setting part
320: button part
321: hall call
322: floor selection
330: up and down passage receiving part
340: up and down passage control part
350: output part
351: screen output
352: sound output
360: up and down passage transmission part
400: voice recognition part
410: voice recognition control part
420: voice recognition DB
FIG. 6
start
S100: elevator operation signal detection
S200: protocol analysis and determination
S300: operation signal transmission and receipt with determined protocol
end
FIG. 7
start
S210: elevator manufacturer information detection
S220: protocol data table search of corresponding manufacturer
S230: protocol data table setting
S240: transmission and receiving with corresponding protocol
end

1. An elevator using a variable communication protocol, comprising:
an up and down passage operation part which detects and outputs an elevator call and a floor selection signal from a passenger of an elevator and displays an operation state of the elevator based on the call and the floor selection;
an elevator operation control part which outputs an operation control signal allowing the elevator to work in accordance with a call and floor selection signal of the elevator from the up and down passage operation part and an operation display signal for a display of the operation state and the arrival state of the elevator; and
a protocol conversion part which converts a communication protocol of the up and down passage operation part or the elevator operation control part for a data communication between the up and down passage operation part and the elevator operation control part hen different communication protocols are used in terms of the signals between the up and down passage operation part and the elevator operation control part.

2. The elevator of claim 1, wherein said protocol conversion part comprises:
a protocol transceiver part for transmitting and receiving a communication protocol between the up and down passage operation part and the elevator operation control part;
a protocol analysis part which analyzes a communication protocol transmitted to and received from the protocol transceiver part and outputs as a previously set communication protocol between the up and down passage operation part and the elevator operation control part; and
a protocol control part which outputs an operation signal to the up and down passage operation part or the elevator operation control part in accordance with the communication protocol from the protocol analysis part.

3. The elevator of claim 2, further comprising:
a protocol setting part for setting a manufacturer information of the up and down passage operation part and the elevator operation control part; and
a protocol table for storing a communication protocol data previously set in accordance with the manufacturer of the up and down passage operation part and the elevator operation control part set from the protocol setting part.

4. The elevator of claim 1, further comprising:
a voice recognition part which is installed at the up and down passage operation part or the elevator operation control part for thereby detecting and outputting an elevator call and a floor selection signal in a way of voice recognition from the passenger of the elevator.

5. A control method using a variable communication protocol, comprising:
(a) a step in which a protocol conversion part detects an elevator operation signal from the up and down passage operation part and the elevator operation control part;
(b) a step in which when the elevator operation signals use different communication protocols, the protocol conversion part analyzes the communication protocols of the up and down passage operation part and the elevator operation control part so that a data communication can be made between the up and down passage operation part and the elevator operation control part, and converts one communication protocol of the up and down passage operation part or the elevator operation control part in accordance with the analyzed result; and
(c) a step in which the protocol conversion part allows an elevator operation signal to be transmitted and received between the up and down passage operation part and the elevator operation control part in accordance with the determined communication protocol.

6. The method of claim 5, wherein said step (b) comprises:
a step in which the protocol conversion part detects a manufacturer information of the up and down passage operation part and the elevator operation control part;
a step for searching a communication protocol data table of the previously set manufacturer in accordance with the detected manufacturer information; and
a step in which the communication protocol data table of the searched manufacturer is set as a communication protocol conversion table between the up and down passage operation part and the elevator operation control part, and the elevator operation signal converted based on the set communication protocol data table is transmitted and received.

7. The method of claim 5, further comprising a step (d) in which the protocol conversion part outputs a call and floor selection signal of the elevator in which the voice is recognized by the voice recognition part is outputted for a communication protocol for the use of the up and down passage operation part and the elevator operation control part.

8. The method of claim 6, further comprising a step (d) in which the protocol conversion part outputs a call and floor selection signal of the elevator in which the voice is recognized by the voice recognition part is outputted for a communication protocol for the use of the up and down passage operation part and the elevator operation control part.

9. The elevator of claim 2, further comprising:
a voice recognition part which is installed at the up and down passage operation part or the elevator operation control part for thereby detecting and outputting an elevator call and a floor selection signal in a way of voice recognition from the passenger of the elevator.

10. The elevator of claim 3, further comprising:
a voice recognition part which is installed at the up and down passage operation part or the elevator operation control part for thereby detecting and outputting an elevator call and a floor selection signal in a way of voice recognition from the passenger of the elevator.
